(19) United States
(12) Patent Application Publication
(10) Pub. No.: US 2008/0231105 A1
(43) Pub. Date: Sep. 25, 2008

(54) Spoked Wheel of a Tubeless Type for Vehicles, in Particular for Motorcycles and Motor Vehicles

(75) Inventors: Giuseppe Ulisse Gittani, Vanzago (Milano) (IT); Gabrielle Perris Magnetto, Rivoli (Torino) (IT)

Correspondence Address: SEED INTELLECTUAL PROPERTY LAW GROUP PLLC, 701 FIFTH AVE, SUITE 5400, SEATTLE, WA, 98104, US

(73) Assignee: GIANETTI RUOTE S.P.A., Ceriano Laghetto (IT)

(21) Appl. No.: 12/067,568

(22) PCT Filed: Sep. 20, 2006
(86) PCT No.: PCT/IB06/53397

§ 371 Date: Mar. 20, 2008

(30) Foreign Application Priority Data
Sep. 20, 2005 (IT) TO2005A000648

(51) Int. Cl. B60B 21/06

(52) U.S. Cl. 301/58

(57) ABSTRACT

The spoked wheel comprises a rim, a hub and a plurality of spokes which connect the rim to the hub and are connected to the rim by means of nipples inserted in a corresponding plurality of drilled seats in the rim. The rim defines a concave outer cylindrical surface having a channel-like configuration with a bottom and a pair of flanks which extend from the opposing sides of the bottom of the rim. According to the invention, the rim includes a first rim part and a second rim part which are separate from one another, wherein the first rim part comprises a radially outer cylindrical portion forming the whole bottom of the rim and the second rim part comprises a radially inner cylindrical portion having the drilled seats. Preferably, the first and second rim parts are detachably joined together by threaded connection members.

### CROSS REFERENCES TO RELATED APPLICATIONS

This application is the U.S. national stage of international application no. PCT/IB2006/053397, filed Sep. 20, 2006, which claims benefit from Italian application no. TO2005A000648, filed Sep. 20, 2005, which applications are hereby incorporated by reference in their entirety.

### BACKGROUND

1. Technical Field

The present invention relates to a spoked wheel for vehicles, in particular for motorcycles and motor vehicles. The invention relates more particularly to a spoked wheel of the so-called tubeless type, i.e. adapted to receive a tyre without an air chamber.

2. Description of the Related Art

As is known, a spoked wheel basically comprises a rim, a hub and a plurality of spokes connected at their opposite ends to the rim and the hub. The rim forms a concave outer cylindrical surface having a channel-like configuration with a bottom and a pair of flanks which may be differently profiled and extend from the opposite sides of the bottom of the rim. The rim defines, together with a tyre fitted thereon, a closed chamber intended to be inflated with air or with another pressurised gaseous medium. The spokes are connected at their inner ends to a pair of flanges of the hub and at their outer ends to the rim by means of threaded connection members known as nipples. Each nipple comprises, in a manner known per se, a cylindrical stem provided with a threaded axial hole intended to engage the outer end, which is also threaded, of a spoke and a discoid head of a width greater than the stem. To make it possible to screw the nipple to the threaded end of the spoke and thus to adjust the tension of the spoke, the head has a notch for a screwdriver and/or the leg has a prismatic shape intended to be coupled with a corresponding slot of an appropriate spoke tightener. The nipples are housed in appropriate seats provided on the bottom of the rim, each of which has a through hole through which the leg of a nipple projects radially from the rim towards the hub.

Conventional spoked wheels nevertheless have the drawback of a non-perfect air-tightness at the points of connection between the rim and the spokes. This drawback is particularly serious in the case of spoked wheels of a tubeless type since, in this case, the air leakages through the rim entail a reduction in the tire inflating pressure.

To remedy the above-mentioned drawback, spoked wheels have been proposed in which the seats for the nipples are provided at the sides rather than at the centre of the bottom of the rim, so that they are outside the area of the rim which defines, with the tyre, the chamber in which the pressurised air is contained. Such a solution nevertheless has the drawback that it spoils the aesthetic appearance of the wheel.

A tubeless-type spoked wheel according to the preamble of claim 1 is known from DE 39 15 490 A1. According to this known solution, the rim of the wheel consists of a first rim part having a radially outer cylindrical portion which forms the whole bottom of the rim and of a second rim part having a radially inner cylindrical portion in which a plurality of drilled seats for connection of the spokes to the rim are provided. The first rim part forms a first pair of flanges which project radially inwards from an end and from the centre of the radially outer cylindrical portion. The second rim part forms a second pair of flanges which project radially outwards from the radially inner cylindrical portion and overlap each with a respective flange of the first rim part. A plurality of transverse through holes are provided in the flanges of the two rim parts for insertion of bolts, by means of which the two rim parts are joined together.

### BRIEF SUMMARY

The object of the present invention is therefore to provide a spoked wheel of a tubeless type for vehicles which is able to ensure a perfect air-tightness and which, at the same time, retains the conventional arrangement of the points of connection of the spokes in the central zone of the rim.

This and other objects are fully achieved according to the invention thanks to a spoked wheel of a tubeless type having the characteristics set out in the characterising part of claim 1.

In summary, the invention is bottomed on the idea of making the wheel rim in two separate parts, one comprising a radially outer cylindrical portion forming the whole bottom of the rim and the other comprising a radially inner cylindrical portion having through seats for connection of the spokes to the rim.

The through seats for connection of the spokes to the rim may receive the nipples or, as an alternative, the heads of the spokes, the through seats for the nipples being provided in this second case in the hub.

The two rim parts are advantageously detachably joined to one another through the use of threaded connection members which are preferably disposed on the sides of the two cylindrical portions.

According to a preferred embodiment of the invention, a pair of rings of through holes are provided in the radially outer cylindrical portion and a corresponding pair of rings of threaded blind holes are provided in the radially inner cylindrical portion and are adapted to receive screws for fastening the two portions of the rim. The through seats for connection of the spokes to the rim provided in the radially inner cylindrical portion are transversely interposed between the two rings of threaded blind holes. In order to ensure leak-tightness between the two rim parts, a pair of peripheral grooves are formed in the radially inner cylindrical portion for each ring of threaded blind holes, on transversely opposite sides with respect to the respective ring of holes, and are adapted to receive sealing devices such as O-ring seals.

If the through seats in the radially inner cylindrical portion of the rim are arranged to receive the nipples, sealing means may be interposed between each seat and the respective nipple, in particular an O-ring seal according to the teaching provided in European Patent Application EP 1 209 006.

According to a first preferred embodiment of the invention, the two flanks of the rim are each formed by one of the two rim parts. According to a variant of the invention, both flanks of the rim are formed by the rim part comprising the radially outer cylindrical portion.

As the bottom of the rim is formed by a rim part separate from the portion in which the through seats for connection of the spokes to the rim are provided, these latter may be provided in the conventional central position, without thereby spoiling the aesthetic appearance of the rim. Moreover, in order to ensure the leak-tightness of the pressure chamber defined between the rim and the tyre, four O-ring seals transversely encircling the two rings of holes for the connection screws are, for instance, sufficient.

### BRIEF DESCRIPTION OF THE SEVERAL VIEWS OF THE DRAWINGS

Further characteristics and advantages of the invention will become clear from the following detailed description, given purely by way of non-limiting example with reference to the accompanying drawings, in which:

FIG. 1 is a perspective view of a spoked wheel of a tubeless type for vehicles, in particular for motorcycles and motor vehicles, according to the invention.

FIG. 2 is a detailed perspective view showing a section of a spoked wheel of a tubeless type according to a first preferred embodiment of the invention.

FIG. 3 is a further detailed perspective view of the spoked wheel of FIG. 2;

FIGS. 4 and 5 are sectional views of the spoked wheel of FIG. 2, in a plane passing through a spoke on the left-hand side and in a plane passing through a spoke on the right-hand side, respectively;

FIG. 6 is a detailed perspective view showing a section of a spoked wheel of a tubeless type according to a second preferred embodiment of the invention;

FIG. 7 is a further detailed perspective view of the spoked wheel of FIG. 6; and

FIGS. 8 and 9 are sectional views of the spoked wheel of FIG. 6, in a plane passing though a spoke mounted on the left-hand side of the wheel and in a plane passing through a spoke mounted on the right-hand side of the wheel, respectively.

### DETAILED DESCRIPTION

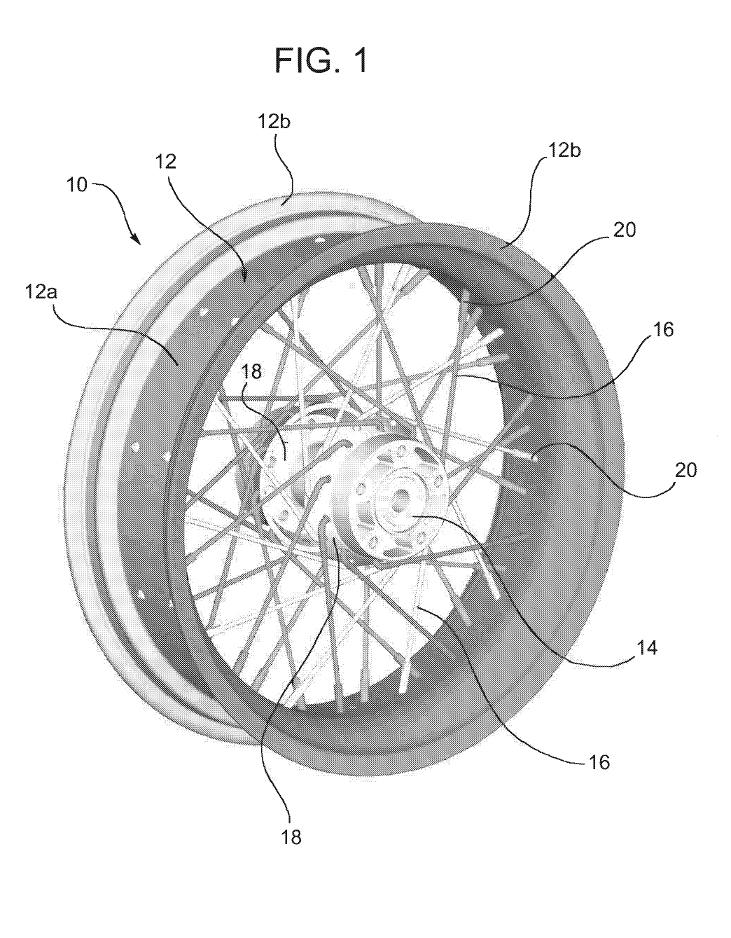

With reference first to FIG. 1, a spoked wheel of a tubeless type for vehicles, in particular for motorcycles and motor vehicles, according to the present invention is generally indicated 10. The spoked wheel 10 comprises a rim 12, a hub 14 and a plurality of spokes 16 which connect the rim 12 to the hub 14. The spokes 16 are secured at their inner ends to a pair of flanges 18 of the hub 14 and at their outer ends to the rim 12. In the embodiment shown, the spokes 16 are in particular secured to the rim 12 by nipples 20 and to the hub 14 by integral head portions.

The hub 14, the spokes 16 and the nipples 20 are per-se-known components and will be not therefore described in detail. As regards the spokes, they may be mounted in the inverse position with respect to the one mentioned above, i.e. secured to the rim by means of their head portions and to the hub by means of the nipples. As regards the structure of the nipples, reference may be made, for instance, to what has already been explained in the preamble of the description.

The rim 12 defines, in a per-se-known manner, a concave outer cylindrical surface having a channel-like configuration with a bottom 12a and a pair of flanks 12b which extend from the bottom 12a.

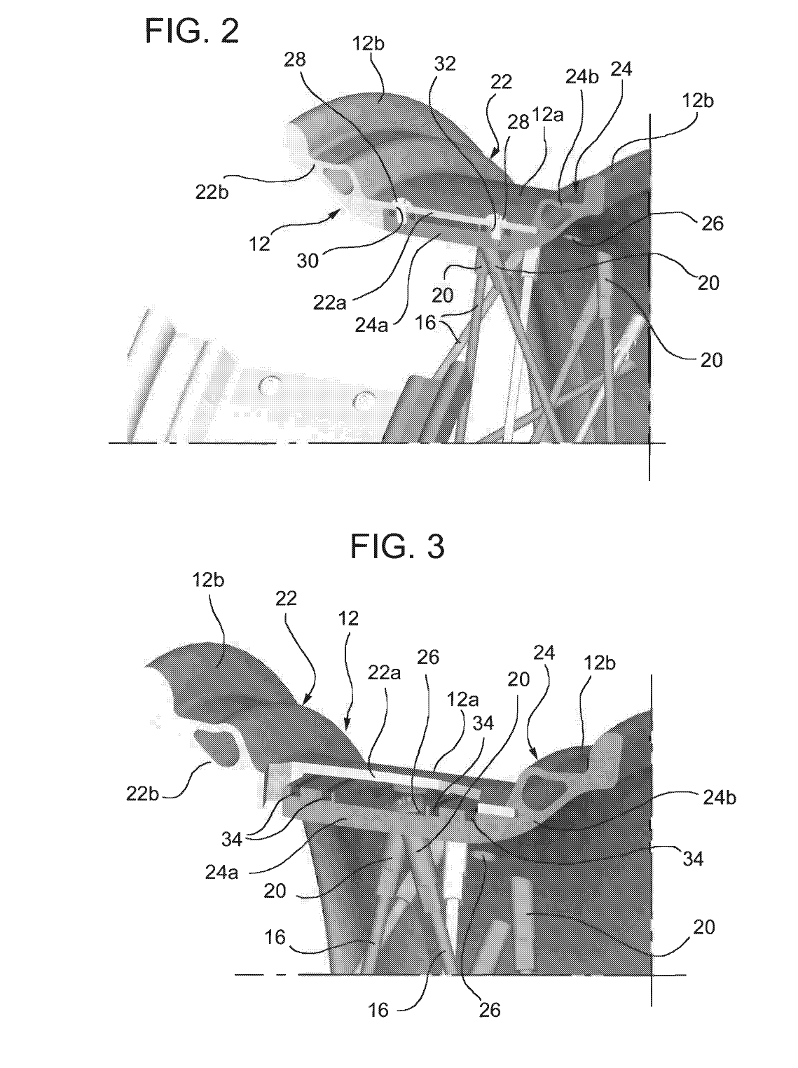

As shown in FIGS. 2 to 9, according to the invention the rim 12 comprises two separate rim parts, a first part 22 and a second part 24 respectively, which are detachably joined to one another, for instance by threaded connection members, as will be better explained in the following part of the description. The first rim part 22 forms a radially outer cylindrical wall portion 22a which defines the whole bottom 12a of the rim 12. The second rim part 24 defines a radially inner cylindrical wall portion 24a adapted to be connected in a position substantially facing the radially outer cylindrical portion 22a of the first rim part 22. The radially inner cylindrical portion 24a has, in a transversely central position, a plurality of through seats 26 for connection of the spokes 16 to the rim 12. In the embodiment shown, the through seats 26 are in particular arranged to receive the nipples 20.

The portion defining the bottom of the rim channel and the portion comprising the through seats for the nipples therefore belong to two separate rim parts. In this way, the through seats for the nipples no longer represent a potential escape route for the pressurised air contained in the chamber defined by the channel of the rim and the tyre, since the holes for the nipples are formed in the radially inner cylindrical portion 24a of the second rim part 24 while the bottom of the rim channel is wholly formed by the radially outer cylindrical portion 22a of the first rim part 22.

With reference now in particular to FIGS. 2 to 5, according to a first preferred embodiment of the invention, the first rim part 22 comprises, in addition to the radially outer cylindrical portion 22a, an appropriately shaped annular lateral portion 22b defining one of the two flanks 12b of the rim 12. Likewise, the second rim part 24 comprises, in addition to the radially inner cylindrical portion 24a, an appropriately shaped annular lateral portion 24b defining the other flank 12b of the rim 12.

The two rim parts 22 and 24 are detachably fastened to one another, preferably by threaded connection members such as screws 28. To this end, in the embodiment shown the radially outer cylindrical portion 22a has a pair of rings of through holes 30 and the radially inner cylindrical portion 24a has a corresponding pair of rings of threaded blind holes 32 into which the screws 28 are screwed. The two rings of holes 30 and 32 are disposed on transversely opposite sides with respect to the through seats 26 for the nipples 20.

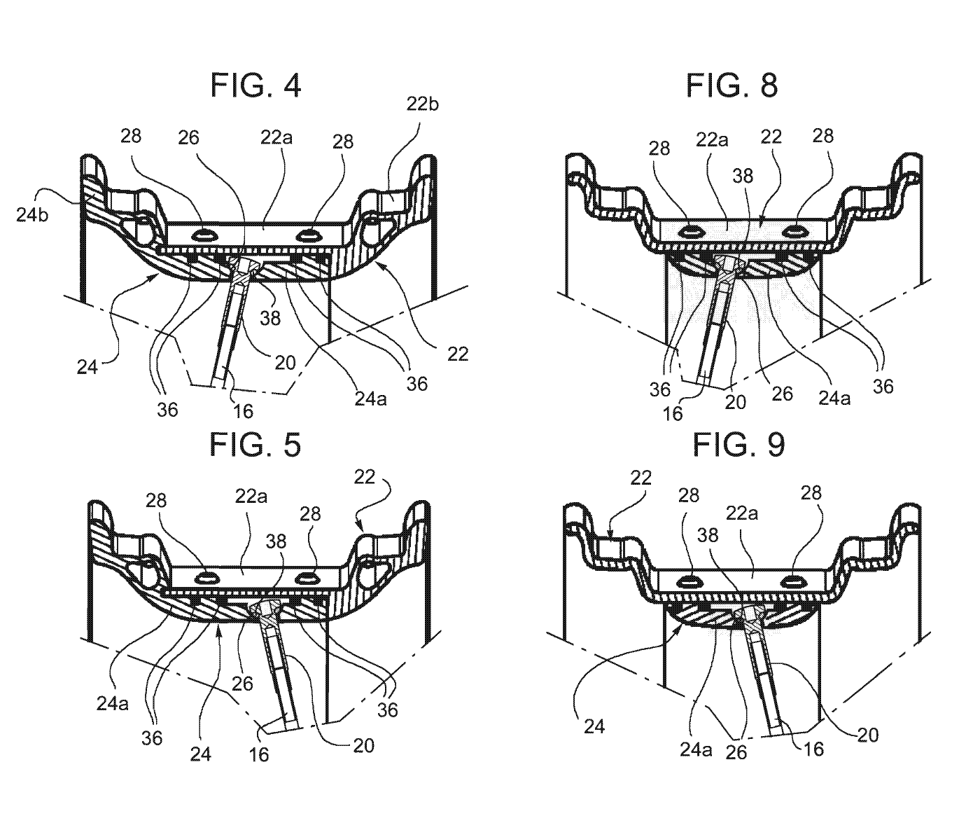

In order to ensure leak-tightness between the two rim parts 22 and 24, a pair of peripheral grooves 34, in which O-ring seals 36 are housed, are provided in the radially inner cylindrical portion 24a on transversely opposing sides with respect to each ring of threaded blind holes 32. This prevents any leakages of air from the pressure chamber defined by the rim and the tyre via the through holes 30 in the radially outer cylindrical portion 22a. As an alternative or in addition to the O-ring seals 36, further sealing means may be interposed between each through seat 26 and the respective nipple 20, in particular an O-ring seal 38 (shown in the sectional views of FIGS. 4 and 5) according to the teaching provided in European Patent Application EP 1 209 006.

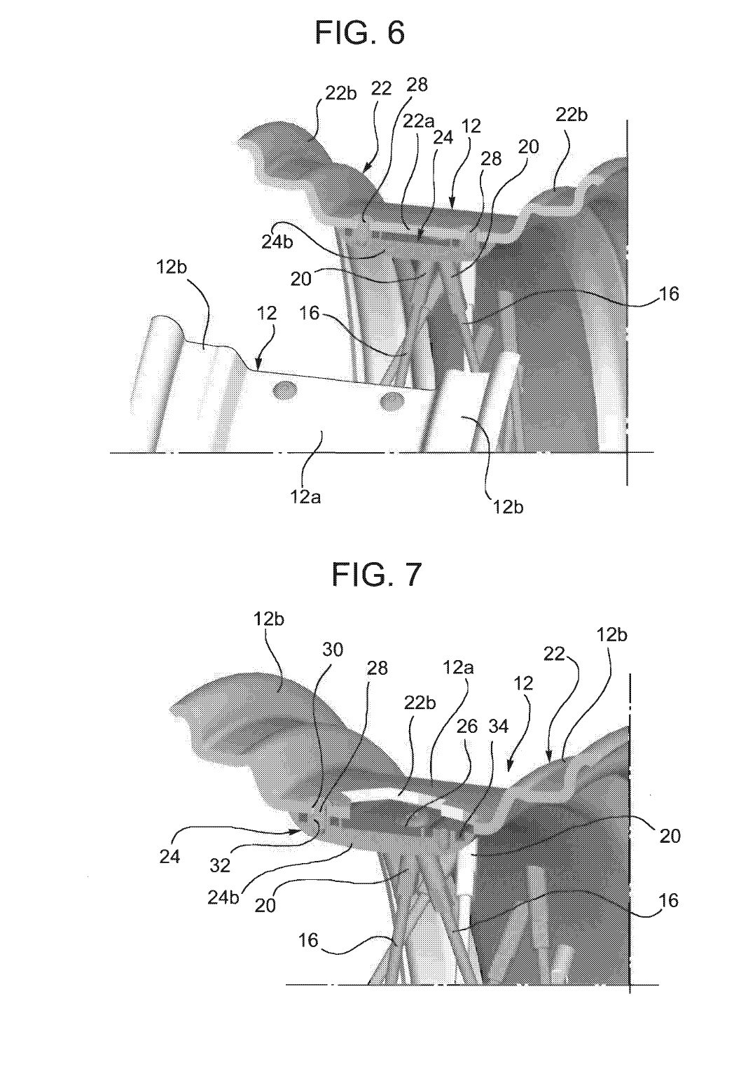

A second preferred embodiment of the invention is illustrated in FIGS. 6 to 9, in which parts or elements identical or corresponding to those shown in FIGS. 2 to 5 have been given the same reference numerals.

This second embodiment differs from the first substantially in that the first rim part 22 defines, in addition to the bottom 12a, both the flanks 12b of the rim 12, while the second rim part 24 is substantially formed solely by the radially inner cylindrical portion 24a in which the seats 26 for the nipples 20 and the peripheral grooves 34 for the O-ring seals 36 are provided.

In this case as well, as an alternative or in addition to the O-ring seals 36, an O-ring seal 38 may be interposed between each through seat 26 and the respective nipple 20, as shown in the sectional views of FIGS. 8 and 9.

As regards the methods of production of the rim, it will be appreciated that any known production method may be used. The two rim parts 22 and 24 may be produced, for instance, by extrusion and/or rolling and the peripheral grooves 34 for the O-ring seals may be obtained either directly by extrusion or subsequently by machine tool working.

Naturally, the principle of the invention remaining unchanged, the embodiments and production details may widely vary from those described and illustrated purely by way of non-limiting example.

For instance, as already set off above, the spokes may be mounted in an inverse position with respect to the one illustrated, i.e. secured to the rim by means of their head portions and to the hub by means of the nipples. In this case, the through seats in the radially inner portion of the rim will therefore be arranged to receive the head portions of the spokes rather than the nipples.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A tubeless-type spoked wheel for vehicles, in particular for motorcycles and motor vehicles, comprising a rim, a hub and a plurality of spokes connected to the rim and the hub,
wherein the rim has a corresponding plurality of through seats each intended for connection of a respective spoke and defines a concave outer cylindrical surface having a channel-like configuration with a bottom and a pair of flanks which extend from the opposing sides of the bottom of the rim,
wherein the rim includes a first rim part and a second rim part which are separate from one another,
wherein the first rim part comprises a radially outer cylindrical portion forming the whole bottom of the rim and the second rim part comprises a radially inner cylindrical portion having said plurality of through seats for connection of the spokes to the rim,
wherein said first and second rim parts are joined together by threaded connection members disposed on transversely opposite sides with respect to the through seats,
the wheel being characterised in that a pair of rings of first holes are provided in the radially outer cylindrical portion and a pair of corresponding rings of second holes are provided in the radially inner cylindrical portion, each first hole being aligned with a corresponding second hole for the insertion of a respective threaded connection member when the rim is assembled.

2. A wheel according to claim 1, wherein said first holes fare through holes and said second holes are threaded blind holes.

3. A wheel according to claim 2, wherein a pair of peripheral grooves are formed in the radially inner cylindrical portion on transversely opposite sides with respect to each ring of second holes and house first sealing means.

4. A wheel according to claim 1, wherein the two flanks of the rim are each formed by one of said first and second rim parts.

5. A wheel according to claim 1, wherein both the flanks of the rim are formed by the first rim part.

6. A wheel according to claim 1, wherein the spokes are connected to the rim by respective nipples and wherein the through seats are arranged to receive the nipples.

7. A wheel according to claim 6, further comprising second sealing means interposed between each nipple and the corresponding through seat.

8. A wheel according to claim 3, wherein said first sealing means includes at least one O-ring seal.

9. A wheel according to claim 7, wherein said second sealing means includes at least one O-ring seal.
